(19) United States
(12) Patent Application Publication
(10) Pub. No.: US 2006/0246407 A1
(43) Pub. Date: Nov. 2, 2006

(54) System and Method for Grading Singing Data

(75) Inventors: Sangwook Kang, Seoul (KR); Jangyeon Park, Seoul (KR)

Correspondence Address: LEE & HAYES, PLLC, 421 W. RIVERSIDE AVE, STE 500, SPOKANE, WA, 99201, US

(73) Assignee: Nayio Media, Inc., San Jose, CA (US)

(21) Appl. No.: 11/380,312

(22) Filed: Apr. 26, 2006

(30) Foreign Application Priority Data
Apr. 28, 2005 (KR) 10-2005-0035311

(51) Int. Cl. G09B 5/00

(52) U.S. Cl. 434/307 A

(57) ABSTRACT

This invention is singing evaluation system and evaluation method for all type Karaoke. Offline, online, wireless Karaoke has Karaoke track and visual display feature. The singing evaluation system extracts user's singing melody in realtime. Extracted melody is expressed in notes of 4-tuple: pitch, onset, duration and sound intensity. User's melody information is visualized and displayed in comparison to original melody of the song. User's singing melody and original melody of the song is compared by each note and when the difference is above pre-set level, grading system's octave is automatically adjusted. User can choose karaoke track type freely enabled by offsent sequence. Another distinctive characteristic of this invention is practice-by-phrase and evaluate-by-phrase function. The function allows users to break down a song to the length of 2 to 3 phrase and practice the specific phrases till perfect.

### TECHNOLOGY AREA WHERE THIS INVENTION LIES AND PREVIOUSLY KNOWN TECHNOLOGY IN THE AREA

This invention is about singing evaluation system and evaluation method. User's singing melody is segmented in notes. Each note of the user's melody is compared to original song's note in four parameters: pitch, onset, duration and sound intensity. The comparison accurately evaluates user's melody. Based on the evaluation result, the user may find out which part was sang inaccurately compared to original song. The user can learn to sing the song in more professional manner by repracticing the weak parts. The singing evaluation system and evaluation method assist user to learn a song which the user does not know accurate melody and exact notes.

Conventionally, Karaoke tracks that guide users to sing or practice a song was for offline Karaoke places. Recently as internet and mobile wirless devices advanced, online Karaoke service on internet platform and mobile wireless platform begain to appear in services.

Offline Karaoke service is offered at a offline site. An offline Karoke site has Karaoke machine, video display device, speaker system and light system. Karaoke machine plays background music chosen by the user. In Karaoke machine, following a play command that triggers musical instrument digital interface (MIDI), background music is outputted. Karaoke machine has approximately 10000 background music tracks, related lyrics and videos. Karaoke machine is updated to new song tracks as occasion calls. Recently, newest Karaoke system at offline Karaoke site has internet networking function. Thus, new song tracks are updated via internet. New song background music, lyrics and video may be upgrared through internet. Users information also may be managed via internet. Karaoke system keeps record of users song selection patters for example and sends the pattern out to Karaoke song track providing server. Such information may be used to provide more user friendly Karaoke system. Good surrounding sound system and light system at offline Karaoke site creates stage like effects. The stage like effect boosts offline Karaoke sites' party like atmosphere and allows users to have fun in groups.

Offline Karaoke system displays evaluation result once user finishes singing along to a track on display screen. However, the evaluation is not based on how accurate the user sang in pitch and tempo. Offline Karaoke system's evaluation is based on how highest or lowest the pitch was or sometimes just a random evaluation point is displayed. Despite the fun factor at offline Karaoke site, the shortcoming is that accurate evaluation is not available. Another weak point of offline Karaoke system is that unless the user is familier with the chosen song, it is very difficult to sing along for only the lyric is available for guidance.

Online Karaoke services advanced based on recent internet technology development and internet usage expansion. Online Karaoke became one of the many online content for internet users. User connects to online Karaoke service web site. User downloads Karaoke program to a pc. In streaming method or download method, background music is played. User connects a michrophone to a PC and sing along to played background music. Online Karaoke service provides various formats of background music; traditional MIDI and MPEG audio layer-3 (MP3) is most widely provided. Distinctive features are evaluation function, recording function, and pitch, tempo and volume control function within the player. Such online Karaoke service does not have stage effect like offline Karaoke site reducing the fun factor of Karaoke service. However, there is less time limitation and fit for users prefer to sing alone at home. There is also hybred services like chatting feature available within online Karaoke services.

Mobile Karaoke service is provided portable devices like mobile handsets or personal digital assistants (PDA). Many digital portable devices now come with MP3 player function and mobile Karaoke service becaome available using MP3 player feature. As in online Karaoke, using mobile wireless internet, user conntects to a web site and download Karaoke program on a portable digital device. Mobile Karaoke service's greatest advantage is it's greaet portability. Practically no limitation of place and time to enjoy Karaoke but display window is too small and compared to Karaoke on PC, the performance is low.

These online Karaoke and mobile Karaoke have evaluation system similar to offline Karaoke. As offline Karaoke, the evaluation system in online Karaoke and mobile Karaoke has too ambiguous evaluation system failing to earn trust from users. The evaluation given for overall singing can not help user to find out which part of the song is user's weakness. In other words, existing Karaoke system is only suitable for singing songs which users are already familier of. Learning to sing a new song is very difficult using existing Karaoke providing just lyric guidance. Most users sing alone on online Karaoke and mobile Karaoke and these services seriously lack fun factor compared to offline Karaoke.

Thus, a way of providing accurate evaluation system based pitch, tempo and sound intensity of user's melody is in need. Phrase by phrase practice function with accurate evaluation system will assist user to upgrade his or her singing abilities. In addition, more effective guidance features for user to learn to sing a new, unfamiliar song are in call.

[Technical Subject which this Invention is Trying to Achieve]

The purpose of this invention is to provide Karaoke, Karaoke evaluation system and evaluation method that evaluates user's melody in each note. User's melody will be segmented to each note level and each note will be evauated in pitch, onset, duration and sound intensity. The evaluation system will help user to enhance singing abilities.

Another purpose of this invention is to add fun features that can stimulate user's interest and diverse singing guidance features that can help user to easily learn to sing new, unfamiliar songs.

### BRIEF DESCRIPTION OF THE DRAWINGS

FIG. 1 illustrates a sequence of processing stages through which an input signal is processed.

FIG. 2 illustrates a device and various modules that perform the methods and functions discussed herein.

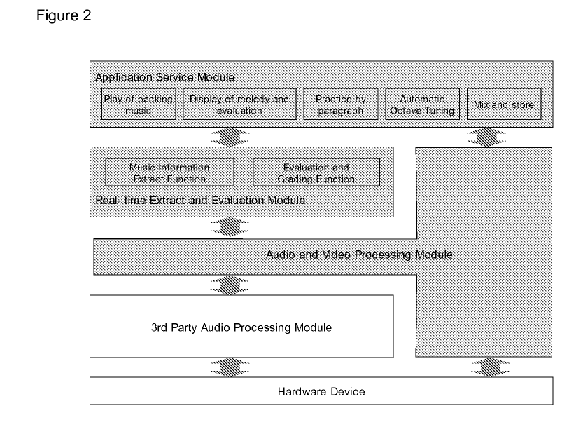

### COMPOSITION OF INVENTION

To accomplish the purose of the invention, user's melody first needs to be represented accurately. Accurate representation of user's melody should be followed by objective validity based evaluation system. For the objective validity, we invited four paratmeters for each note: pitch, onset, duration, and sound intensity. These four parameters are applied in accurate representation of user's melody and the base of evaluation. In order to stimulate user to sing with more excitement, features like automatic octave tuning, real-time switchover of backing music and practice repeat by phrase are provided.

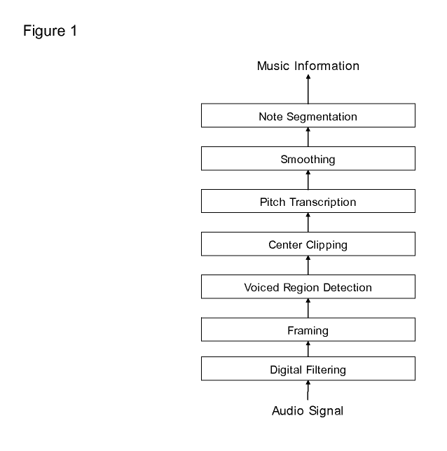

In order to realize a user's melody, this invention accepts the input song by the user, extracts the pitch of the input, segments the pitch sequences into musical notes, and presents them in the user friendly fashion on the display device without delay. The input signal goes through a sequence of processing stages as shown in FIG. 1. At first, the input signal is filtered with a bandpass Butterworth filter. The filtered signal is segmented into the frames 30 msec long which are selected at 10 msec intervals. Thus, the frames overlap by 20 msec. The next five steps are related to the note segmentation and its pitch identification. They are described in more detail in the following.

The purpose of note segmentation is to identify each note's onset and offset boundaries within the signal. The invention used two steps of note segmentation, one based on the signal amplitude and the other on pitch.

In the first step, the amplitude of the input signal is calculated over the time frames within human voice's frequency range, and the resulting value is used to detect the boundaries of the voiced sections in the input stream. The way of the amplitude based note segmentation is to set two fixed thresholds, detecting a start time when the power exceeds the higher threshold and an end time when the power drops below the lower threshold. Amplitude segmentation has the advantage of distinguishing repeated notes of the same pitch.

The pitch based note segmentation is applied only to the voiced regions detected in the first step. In the voiced region, the pitch tracking algorithm uses a hybrid function of an autocorrelation function (ACF) and an average magnitude difference function (AMDF). The voiced region may contain more than one note, therefore, must be segmented further The segmentation on pitch separates all the different frequency notes that are present in the same voiced region.

As for pitch based segmentation, the main idea is to group sufficiently long sequences of the pitches within the allowable range. Frames are first grouped from left to right over the time. A frame whose addition to the current group satisfies that the span of the pitches is less than the predetermined parameter A (0.5≦Δ<1) is included in the segment. If the addition of a frame to the segment violates the above condition, it means the end of the segment. A new segment started to be searched from a frame whose pitch is different from that of the starting frame of the previous segment. When all segments are found in the voiced region, the note detection algorithm has to be conducted. A note is extended from the left by incorporating any segments on the right until encountering a segment whose average is out of the allowable range of the current note. When note transitions are found but the current segment is not long enough, the short segment is not considered as a meaningful note, since it may correspond to the transient region of the singing voice.

The methodology for note segmentation at each frame is summarized in the following algorithm:
1) Detect if this frame is in the voiced region
   A. Compute the magnitude of the time frame
   B. If it is not in the voiced region and the magnitude of the frame is greater than the higher threshold, a new voiced region starts at this frame
   C. If it is in the voiced region and the magnitude of the frame drops below the lower threshold, the voiced region stop at the previous frame
   D. If the frame is not in the voiced region, do not proceed to the next steps
2) Determine if this frame is grouped to the which segments
   A. Compute the pitch p of the frame
   B. If it is not equal to that of the previous frame, a new segment is added to the current segment list {sₙ|n≧1}, where sₙ is denoted as (tₙ^{s}, tₙ^{e}). tₙ^{s} is the start time of the n-th segment and tₙ^{e} is the current time
   C. For each segment sₙ, calculate the maximum max{sₙ} and the minimum min{sₙ}
   D. Incorporate the frame into the segment sₙ if it satisfies
      |p−sₙ^{max}|≦Δ and |p−sₙ^{min}|≦Δ
3) Identify a note in the segment list
   A. Choose the valid segment list {sₙ^{v}|n≧1} from {sₙ|n≧1} satisfying that its length should be greater than Tₘᵢₙ
   B. Compute the pitch averages {mₙ^{v}|n≧1} for each element in the valid segment list
   C. For each sₙ^{v}, determine if it is included in the current note
   D. If it is, delete it from both {sₙ^{v}|n≧1} and {sₙ|n≧1}

An automatic octave tuning is applied to the first phrase, two or three bars in which the user starts singing. In the subsequent phrases, the result of the octave tuning is used to adjust the user's own tune to that of the record music track. The pitch of the identified note from the user singing is denoted as MIDI note number (aka semitone). In the MIDI note number notation, C4 is assigned 48 and the octave C5 of the C4 is 60, thus the span of the octave is 12. An automatic octave tuning in the invention adapt user's singing tune to that of the recorded music track at integral multiple of the octave span, i.e. ±12k (k=0, 1, 2, . . . ). The octave tuning value a is calculated over the octave tuning interval as follows.
1) Compute the average m of the corresponding pitches from the song information file
2) When the k-th note is detected from the user's singing and its calculated pitch is denoted as pₖ^{o}, calculate cc satisfying

$$\vert \frac{{\sum }_{n = 1}^{k} {p}_{n}^{o}}{k} - m + α \vert \leq 6 , where α = \pm 12 i ( i = 0 , 1 , 2 , … )$$
3) The user's pitch is adjusted as follows
   pₙ=pₙ^{o}+α, (n=1, . . . , k)

The real-time switchover of backing music is particulary applied to this invention for easy learning and practice of a song. In the process of singing you will be able to change a backing music from the instrumental accompaniment to the original song track, and vice versa. The instrumental accompaniment is a recorded music without vocal track. On the other hand, the original song track is a recorded song which is included with not only an instrumental accompaniment and vocal track.

Therefor, when user sings unfamiliar new song, user can set to original song track and sing along to original artist's vocal and learn the song. Once the user become somewhat familiar with the song, user can switch to instrumental accompaniment and sing alone with confidence like the original artist. This invention allows user to choose instrumental accompaniment for confident phrases in a song and switch to original song track when unsure phrases appear in the same song. Such a selection and switch of Karaoke track helps user to learn the song more effectively while having fun.

In order to provide such a feature, in this invention, each song is designed to have two backing music; original song track & instrumental accompaniment. Each backing music has offset sequence that recognizes each note. One song's instrumental accompaniment and original song track has start offset of 0 and end offset of same point. Thus, instrumental accompaniment and original song track has identical offset sequence in any specific phrase of a song.

Each song has two backing music available for play. While one of the backing music is in play and user switch to the other backing music. In this case, this invention reads offset count of playing phrase and plays the latter bacing music in sequence. Thus, backing music continued unaffected without any loss or confusion. The prior backing music in stop status, before the latter backing music is played there could be minutely delay. However, such minutely delay between two backing music can be restored by general algorithm.

This invention provides “repeat practice by phrase” function. To provide this function, one song is divided into many sections and in evaluation result page, the result is shown by each section. Each section is displayed in 2 to 3 bars, based on where average singer is expected to take a breath.

When user chooses a section, the system of this invention plays backing music from the chosen section's start offset and user sings along. To provide preparation time for the user, the system is design to track 3 seconds before start offset of the chosen section and play from there on.

This invention has above descripted technical functions as distinguished features. Consisted of application service module, real-time extract & evaluation module, audio & video processing module. In addition, the 3^{rd} party audio processing module and hardware device are supplemented to provide service to users.

Application service module has guidance display function and user's input/selection function. The module is consisted of backing music selction & play function, original melody & evaluation result display function, repeate practice by phrase, auto octave adjustment function, and lastly mixing & saving function. Backing music selection & play function is designed using real-time switch over of backing music previously explained. Mixing & saving function is a feature which mixes and saves user's singing voice and backing music. Mixing method is generally used algorithm. When user's singing voice and backing music has different bitrate, based on interpolation, the two sources are mixed.

Real-time extract & evaluation module provides backing music information in realtime. The module also extracts melody information from user's singing voice. The module has music information extract function and evaluation & grading function. The former is used for displaying user's singing melody in realtime and the latter is used for comparison based evaluation of original melody and user's melody.

To extract melody from user's singing voice, general pitch tracking method is invited. After melody extraction, the entire melody is represented in a note of 4-tuple: pitch, offset, duration and sound intensity. For evaluation, each note of user's melody is compared to original melody using each parater of 4-tuple for each note and point is given based on similarity.

Audio & video processing module receives audio data and video data from hardware device or 3^{rd} party audio processing module. Audio & video processing module digitalizes received data and sends the data out real-time extract & evaluation module and application service module.

1. For Sing-a-long background music track and display function provided online, off-line, wire and wireless environment Karaoke using evaluation system,
Song track related lyric information, background music information, and database of pitch and/or tempo information of the song to display pitch and tempo of each phrase or note of the song;
Above background music data is exported via speaker, and audio data processing block that changes to a format that is comparable to user's singing performance data;
Video data processing block that displays comparison of song data processed through above audio data processing block and above pitch and tempo data; and
Evaluation block that evaluates based on the matching level of above song data and pitch & tempo data.
This singing evaluation system includes such as a distinctive feature.

2. In claim 1, above audio data processing block consists of
Above song data digitalizing A/D converter and, above digitalized song data filtering digital filter
This singing evaluation system includes such as a distinctive feature.

3. In claim 1, above evaluation block consists of
Onset voice region detection that detects filtered song data's each phrase or note starting point based on the size of sound energy;
Note duration time detection that finds above song data's each phrase or note ending point and calculates duration of each phrase or note;
Note information extracting function that extracts pitch value of above each phrase or note; and
Evaluation function that compares above song data's each phrase or note continue time and at least one of above pitch value to above pitch and tempo data and calculates evaluation assessment.
This singing evaluation system includes such as a distinctive feature.

4. In claim 3, above note duration time detection
Considers each phrase or note's ending point as where there is sudden decrease in sound energy size.
This singing evaluation system includes such as a distinctive feature.

5. In claim 4, above note duration time detection
Considers from above onset voice region detection point to new onset detected point as where previous phrase or note ends.
This singing evaluation system includes such as a distinctive feature.

6. In claim 3, above note information extracting function
Determines note value by the sound's distinctive basic audio frequency and pitch value which expresses sound's high and low in numerical value.
This singing evaluation system includes such as a distinctive feature.

7. In claim 3, above evaluation function
makes evaluation assessment by average of matching level of duration time between above song data and above pitch and tempo data duration time; and above pitch value.
This singing evaluation system includes such as a distinctive feature.

8. In claim 3, above evaluation function
Gives weight to one of the followings above matching level of duration time between above song data and above pitch and tempo data duration time; or above pitch value. Based on the weight-based recalculation, evaluation assessment is made
This singing evaluation system includes such as a distinctive feature.

9. In claim 1, above video data processing block
Displays note that has each song's pitch and tempo data at a specific location based on the above each note's high-low and length, in a pre-defined length bar format pitch and tempo graphs.
This singing evaluation system includes such as a distinctive feature.

10. In claim 9, above video processing block
Displays note's duration and pitch value extracted by above evaluation function in above pitch and tempo graph.
This singing evaluation system includes such as a distinctive feature.

11. Sing-a-long background music track and display function provided online, off-line, wire and wireless environment Karaoke using evaluation system includes,
Input step where based on users selection, background music track is played via speaker and receives user's singing performance data information;
Change step which changes above singing performance data input to a format that is comparable to pitch and tempo data—above pitch and tempo data is for displaying pitch & tempo information of each song's each phrase or note—;
Display step which above changed song data and above pitch & tempo data is compared and displayed; and
Evaluation step which evaluates based on the matching level of above song data and pitch and tempo data.
This singing evaluation method includes such as a distinctive feature.

12. In claim 11, above background music track data and above pitch and tempo data may be saved in database in advance or downloaded in real-time via communication network.
This singing evaluation method includes such as a distinctive feature.

13. In claim 11, above evaluation step has
Phrase or note beginning point finding process of filtered song data based on the size of sound energy;
Phrase or note ending point finding process;
Each phrase or note duration time calculation process using above beginning point and ending point;
Pitch value extracting process for above phrase or note; and
Evaluation assessment calculating process based on the comparison of above song data's each phrase or note duration time and at least one of above pitch and tempo data.
This singing evaluation method includes such as a distinctive feature.

14. In claim 13, above evaluation assessment calculation step has
Above note's duration time matching level and above note value matching level between above song data and above pitch and tempo data calculating and the average value calculating step. This singing evaluation method includes such as a distinctive feature.
This singing evaluation method includes such as a distinctive feature.

15. In claim 13, above evaluation assessment calculation step includes
Giving weight to one of the followings above matching level of duration time between above song data and above pitch and tempo data duration time; or above pitch value. Based on the weight-based recalculation, evaluation assessment is made.
This singing evaluation method includes such as a distinctive feature.

16. In claim 11, above display step has
Note included in above each song's pitch and tempo data graphic displaying step based on each note's high-long and length; and
Duration time pitch value extracted from note in above song data graphic displaying step.
This singing evaluation method includes such as a distinctive feature.

17. In claim 11, above song evaluation method has
Above evaluation result by each phrase saving step;
User chosen, and generated each phrase based evaluation result extracting and displaying step; and
Re-evaluation step for specific phrase chosen by the user to be re-performed and evaluated based on the new input.
This singing evaluation method includes such as a distinctive feature.

18. Recording-medium with computer programming to execute either one of claim 17.
